(19) United States
(12) Patent Application Publication
(10) Pub. No.: US 2022/0391142 A1
(43) Pub. Date: Dec. 8, 2022

(54) INFORMATION PROCESSING DEVICE, INFORMATION PROCESSING METHOD, AND INFORMATION PROCESSING PROGRAM

(71) Applicant: FUJIFILM CORPORATION, Tokyo (JP)

(72) Inventors: Michitaka KONDO, Tokyo (JP); Yutaka OISHI, Tokyo (JP); Takashi MIYAMOTO, Tokyo (JP); Terue WATANABE, Tokyo (JP); Koji MATSUMURA, Tokyo (JP); Yuko UNO, Tokyo (JP)

(21) Appl. No.: 17/819,320

(22) Filed: Aug. 12, 2022

Related U.S. Application Data
(63) Continuation of application No. PCT/JP2020/038130, filed on Oct. 8, 2020.

(30) Foreign Application Priority Data
Feb. 28, 2020 (JP) 2020-034306

(51) Int. Cl. G06F 3/06

(52) U.S. Cl. CPC G06F 3/0659; G06F 3/0634; G06F 3/0686; G06F 3/0604

(57) ABSTRACT

An information processing device performs, in a case where, out of a plurality of magnetic tapes on which data is multiplexed and recorded, the number of the magnetic tapes which is equal to or more than a predetermined number of multiplexes are stored in a storage unit, first control to handle each magnetic tape stored in the storage unit, to be readable and writable, and performs, in a case where the number of the magnetic tapes which is less than the number of multiplexes are stored in the storage unit, second control to handle the magnetic tape stored in the storage unit, to be read-only.

### CROSS-REFERENCE TO RELATED APPLICATIONS

This application is a continuation application of International Application No. PCT/JP2020/038130, filed on Oct. 8, 2020, the disclosure of which is incorporated herein by reference in its entirety. Further, this application claims priority from Japanese Patent Application No. 2020-034306, filed on Feb. 28, 2020, the disclosure of which is incorporated herein by reference in its entirety.

### BACKGROUND

### 1. Technical Field

The present disclosure relates to an information processing device, an information processing method, and an information processing program.

### 2. Description of the Related Art

Conventionally, the same data has been multiplexed and stored in a plurality of storage devices for the purpose of data redundancy and the like (see JP2009-37567A and JP2003-257127A).

### SUMMARY

Incidentally, since a magnetic tape has relatively high portability, for example, a magnetic tape used in a first system may be used in a second system different from the first system. In this case, in a case where data is multiplexed and recorded on a plurality of magnetic tapes in the first system, the multiplicity of the data that is multiplexed and recorded on the magnetic tapes may be inconsistent, for example, in a case where the data is added to a part of a plurality of magnetic tapes in the second system.

The present disclosure has been made in view of the above circumstances, and an object thereof is to provide an information processing device, an information processing method, and an information processing program capable of maintaining the consistency of the multiplicity of data multiplexed and recorded on a magnetic tape.

According to the present disclosure, there is provided an information processing device comprising: at least one processor, in which the processor performs, in a case where, out of a plurality of magnetic tapes on which data is multiplexed and recorded, the number of the magnetic tapes which is equal to or more than a predetermined number of multiplexes are stored in a storage unit, first control to handle each magnetic tape stored in the storage unit, to be readable and writable, and performs, in a case where the number of the magnetic tapes which is less than the number of multiplexes are stored in the storage unit, second control to handle the magnetic tape stored in the storage unit, to be read-only.

In the information processing device of the present disclosure, the processor may further acquire first identification information which is identification information of a system in which the data is recorded on the plurality of magnetic tapes, and may perform the first control in a case where second identification information, which is identification information of a system to which the information processing device belongs, and the first identification information match.

Further, in the information processing device of the present disclosure, the predetermined number of multiplexes may be a value that satisfies a majority of the number of magnetic tapes on which the data is multiplexed and recorded.

Further, in the information processing device of the present disclosure, the predetermined number of multiplexes may be a value equal to the number of magnetic tapes on which the data is multiplexed and recorded.

Further, in the information processing device of the present disclosure, the storage unit may be a slot of a tape drive or a tape library.

Further, according to the present disclosure, there is provided an information processing method executed by a processor provided in an information processing device, the method comprising: performing, in a case where, out of a plurality of magnetic tapes on which data is multiplexed and recorded, the number of the magnetic tapes which is equal to or more than a predetermined number of multiplexes are stored in a storage unit, first control to handle each magnetic tape stored in the storage unit, to be readable and writable; and performing, in a case where the number of the magnetic tapes which is less than the number of multiplexes are stored in the storage unit, second control to handle the magnetic tape stored in the storage unit, to be read-only.

Further, according to the present disclosure, there is provided an information processing program for causing a processor provided in an information processing device to execute a process comprising: performing, in a case where, out of a plurality of magnetic tapes on which data is multiplexed and recorded, the number of the magnetic tapes which is equal to or more than a predetermined number of multiplexes are stored in a storage unit, first control to handle each magnetic tape stored in the storage unit, to be readable and writable; and performing second control to handle the magnetic tape stored in the storage unit, to be read-only, in a case where the number of the magnetic tapes which is less than the number of multiplexes are stored in the storage unit.

According to the present disclosure, it is possible to maintain the consistency of the multiplicity of data multiplexed and recorded on a magnetic tape.

### BRIEF DESCRIPTION OF THE DRAWINGS

FIG. 1 is a block diagram showing an example of a configuration of a recording and reproducing system.

FIG. 2 is a block diagram showing an example of a configuration of a magnetic tape cartridge.

FIG. 3 is a block diagram showing an example of a configuration of a tape drive.

FIG. 4 is a diagram illustrating processing of multiplexing and recording data on a plurality of magnetic tapes.

FIG. 5 is a diagram illustrating information recorded on the magnetic tape cartridge.

FIG. 6 is a block diagram showing an example of a hardware configuration of an information processing device.

FIG. 7 is a block diagram showing an example of a functional configuration of the information processing device.

FIG. 8 is a diagram illustrating a situation in which the magnetic tape is readable and writable.

FIG. 9 is a diagram illustrating a situation in which the magnetic tape is read-only.

FIG. 10 is a flowchart showing an example of magnetic tape control processing.

### DETAILED DESCRIPTION

Hereinafter, examples of embodiments of the technique of the present disclosure will be described in detail with reference to the drawings.

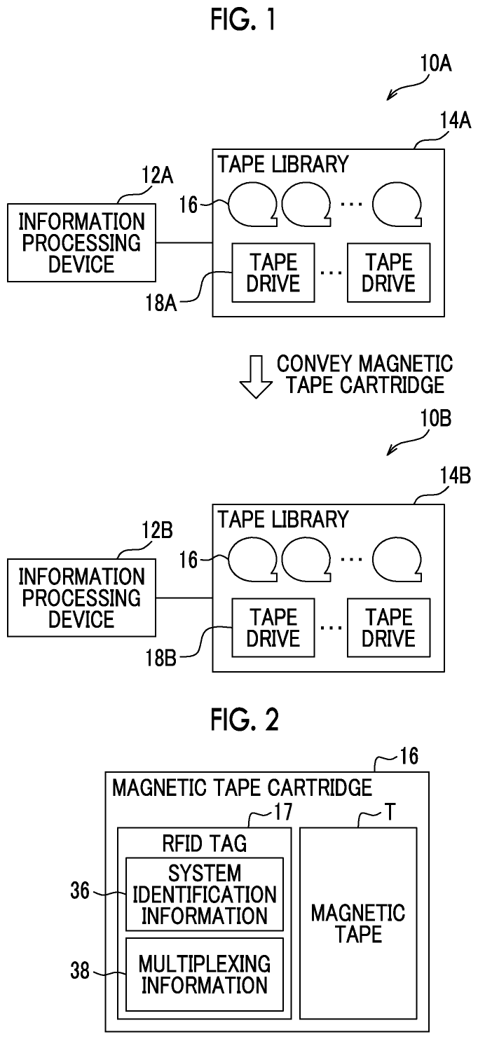

First, configurations of recording and reproducing systems 10A and 10B according to the present embodiment will be described with reference to FIG. 1. As shown in FIG. 1, the recording and reproducing system 10A includes an information processing device 12A and a tape library 14A. In addition, the recording and reproducing system 10B includes an information processing device 12B and a tape library 14B.

The tape library 14A comprises a plurality of slots (not shown) and a plurality of tape drives 18A, and a magnetic tape cartridge 16 is stored in each slot. Each tape drive 18A is connected to the information processing device 12A. The tape library 14B comprises a plurality of slots (not shown) and a plurality of tape drives 18B, and a magnetic tape cartridge 16 is stored in each slot. Each tape drive 18B is connected to the information processing device 12B. An example of the magnetic tape cartridge 16 includes a linear tape-open (LTO) tape cartridge. In the present embodiment, an example in which the magnetic tape cartridge 16 on which data is recorded in the recording and reproducing system 10A is conveyed to the recording and reproducing system 10B will be described.

Next, a configuration of the magnetic tape cartridge 16 according to the present embodiment will be described with reference to FIG. 2. As shown in FIG. 2, the magnetic tape cartridge 16 comprises a magnetic tape T on which information is magnetically recorded, and a radio frequency identifier (RFID) tag 17 as an example of a recording medium capable of recording and reading information through wireless communication or the like in a contactless manner. System identification information 36 and multiplexing information 38 are recorded on the RFID tag 17. The system identification information 36 includes a system ID as an example of identification information of a recording source system in which data is recorded on the magnetic tape T. For example, in a case where data is recorded on the magnetic tape T by the recording and reproducing system 10A, the system identification information 36 includes the system ID of the recording and reproducing system 10A. The multiplexing information 38 will be described later. The system identification information 36 and the multiplexing information 38 may be recorded on, for example, the magnetic tape T instead of the RFID tag 17.

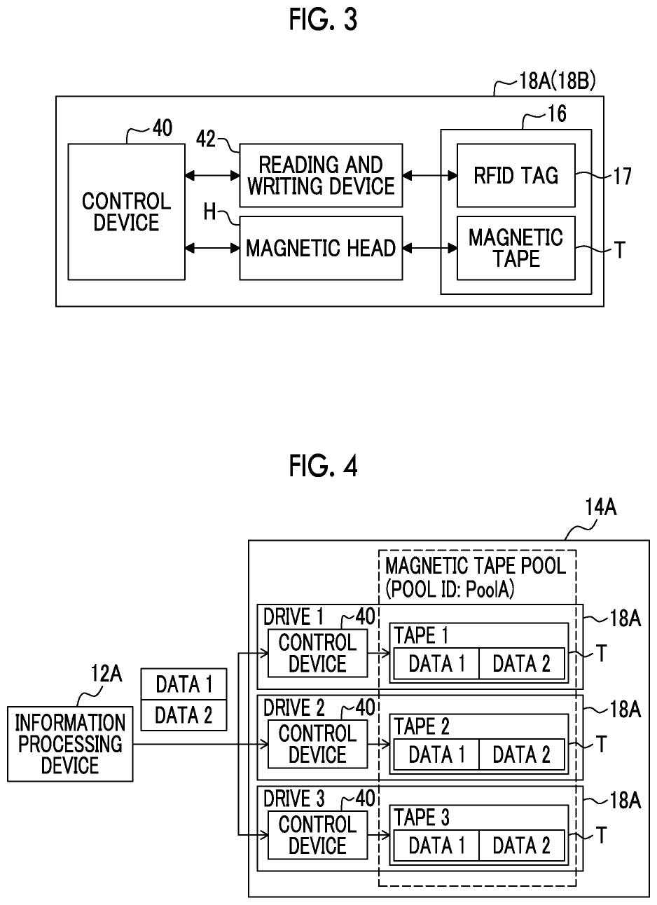

Next, a configuration of the tape drive 18A according to the present embodiment will be described with reference to FIG. 3. As shown in FIG. 3, the tape drive 18A comprises a control device 40, a reading and writing device 42, and a magnetic head H. In a case where data is written or read with respect to the magnetic tape T of the magnetic tape cartridge 16, the magnetic tape cartridge 16 is stored in the tape drive 18A.

The control device 40 includes a processor, such as a programmable logic device (PLD), a memory serving as a temporary storage area, a non-volatile storage unit, and the like. The control device 40 transmits and receives data to and from the information processing device 12A, controls the reading and writing device 42 and the magnetic head H, and the like.

The reading and writing device 42 reads the information recorded on the RFID tag 17 in a contactless manner through the control performed by the control device 40, and outputs the read information to the control device 40. In addition, the reading and writing device 42 records information on the RFID tag 17 in a contactless manner through the control performed by the control device 40. An example of the reading and writing device 42 includes an RFID reader and writer. The magnetic head H comprises a recording and reproducing element that writes and reads data with respect to the magnetic tape T.

Since the configuration of the tape drive 18B is the same as that of the tape drive 18A, the description thereof will be omitted. The tape drive 18B is an example of the storage unit in which the magnetic tape T is stored.

Next, recording processing of multiplexing and recording data on a plurality of magnetic tapes T with a predetermined number of multiplexes in the recording and reproducing system 10A will be described with reference to FIG. 4. The recording and reproducing system 10A according to the present embodiment has a function of providing a logical volume to the information processing device 12A by using a magnetic tape pool in which magnetic tapes T of a plurality of magnetic tape cartridges 16 are grouped. As shown in FIG. 4, in a case where the information processing device 12A according to the present embodiment performs control to record data on the logical volume provided by the magnetic tape pool, the same data is multiplexed and recorded on the plurality of magnetic tapes T belonging to the magnetic tape pool. FIG. 4 shows an example in which data is multiplexed and recorded on three magnetic tapes T belonging to the magnetic tape pool with a pool ID “PoolA” as an example of the identification information of the magnetic tape pool.

Further, the information processing device 12A performs control to record the multiplexing information 38 including the pool ID and the number of multiplexes on the RFID tag 17 of each of the magnetic tape cartridges 16 belonging to the magnetic tape pool, in a case where the magnetic tape pool is formed. In the present embodiment, the number of multiplexes is set to a value equal to the number of magnetic tapes T belonging to the magnetic tape pool, that is, the number of magnetic tapes T on which data is multiplexed and recorded. Further, the information processing device 12A performs control to record a system ID (hereinafter, referred to as a “first system ID”), as an example of the identification information of the recording and reproducing system 10A which is a system to which the own device belongs, on the RFID tag 17 of each of the magnetic tape cartridges 16 belonging to the magnetic tape pool.

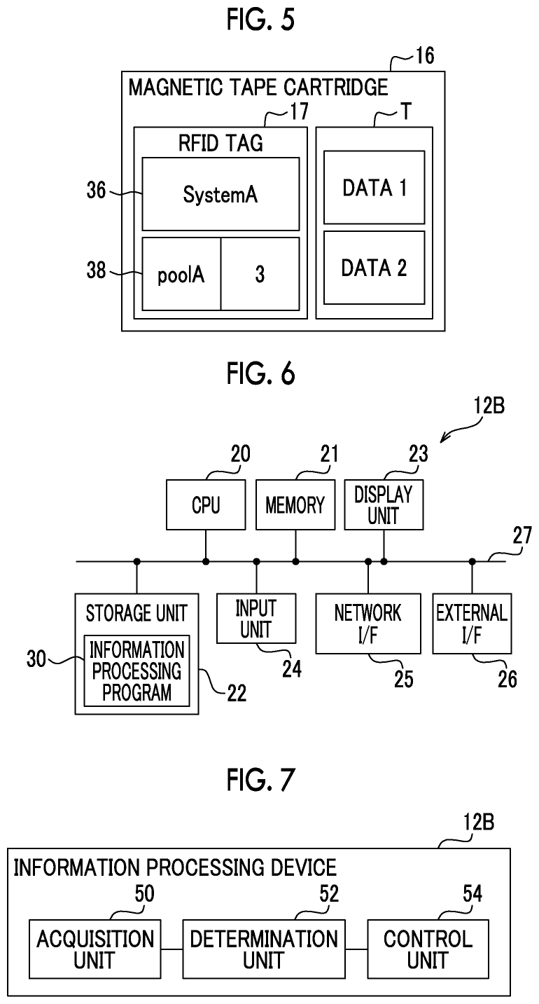

Therefore, as shown in FIG. 5, in the recording and reproducing system 10A, data is multiplexed and recorded on the magnetic tapes T of the plurality of magnetic tape cartridges 16. Further, in the recording and reproducing system 10A, the system ID of the recording and reproducing system 10A in which data is recorded on the magnetic tape T is recorded on the RFID tag 17 of each of the plurality of magnetic tape cartridges 16. The system ID recorded on the RFID tag 17 is an example of the first identification information according to the disclosed technique. Further, in the recording and reproducing system 10A, the multiplexing information 38 including the pool ID and the number of multiplexes is recorded on the RFID tags 17 of the plurality of magnetic tape cartridges 16. In the example of FIG. 5, an example is shown in which the system ID is “SystemA”, the pool ID is “PoolA”, and the number of multiplexes is “3”.

Next, the hardware configuration of the information processing device 12B according to the present embodiment will be described with reference to FIG. 6. As shown in FIG. 6, the information processing device 12B includes a central processing unit (CPU) 20, a memory 21 serving as a temporary storage area, and a non-volatile storage unit 22. In addition, the information processing device 12B includes a display unit 23, such as a liquid crystal display, an input unit 24, such as a keyboard and a mouse, a network interface (I/F) 25 connected to a network, and an external I/F 26 to which each tape drive 18B is connected. The CPU 20, the memory 21, the storage unit 22, the display unit 23, the input unit 24, the network I/F 25, and the external I/F 26 are connected to a bus 27.

The storage unit 22 is realized by a hard disk drive (HDD), a solid state drive (SSD), a flash memory, or the like. An information processing program 30 is stored in the storage unit 22 serving as a storage medium. The CPU 20 reads out the information processing program 30 from the storage unit 22 and then develops the information processing program 30 in the memory 21, and executes the developed information processing program 30. An example of the information processing device 12B includes a server computer.

Next, a functional configuration of the information processing device 12B according to the present embodiment will be described with reference to FIG. 7. As shown in FIG. 7, the information processing device 12B includes an acquisition unit 50, a determination unit 52, and a control unit 54. The CPU 20 executes the information processing program 30 to function as the acquisition unit 50, the determination unit 52, and the control unit 54.

The acquisition unit 50 acquires the system identification information 36 and the multiplexing information 38 from the magnetic tape cartridge 16 stored in each tape drive 18B. Specifically, the acquisition unit 50 outputs an instruction to read the system identification information 36 and the multiplexing information 38 to the control device 40 of each tape drive 18B. The control device 40 controls the reading and writing device 42 and reads the system identification information 36 and the multiplexing information 38 recorded on the RFID tag 17. Then, the control device 40 outputs the read system identification information 36 and multiplexing information 38 to the information processing device 12B. The acquisition unit 50 acquires the system identification information 36 and the multiplexing information 38 input from the control device 40 of each tape drive 18B. In the present embodiment, it is assumed that the system identification information 36 and the multiplexing information 38 are provided with information capable of specifying which magnetic tape cartridge 16 the system identification information 36 and the multiplexing information 38 are read from.

The determination unit 52 determines whether or not the number of the magnetic tape cartridges 16 which is equal to or more than a predetermined number of multiplexes, out of the plurality of magnetic tape cartridges 16 on which data is multiplexed and recorded, are stored in the tape drives 18B. Specifically, the determination unit 52 determines whether or not the number of magnetic tape cartridges 16 having the same pool ID included in the multiplexing information 38 acquired by the acquisition unit 50 is equal to or more than the number of multiplexes included in the multiplexing information 38.

Further, the determination unit 52 determines whether or not a system ID (hereinafter, referred to as a “second system ID”), as an example of the identification information of the recording and reproducing system 10B that is a system to which the information processing device 12B which is the own device belongs, and the first system ID included in the system identification information 36 acquired by the acquisition unit 50 match. The second system ID is an example of the second identification information according to the disclosed technique. The second system ID may, for example, be stored in the storage unit 22 of the information processing device 12B in advance, or be acquired from a management server that manages the recording and reproducing system 10B.

The control unit 54 performs the following control in a case where the determination unit 52 determines that the number of the magnetic tape cartridges 16 which is equal to or more than a predetermined number of multiplexes are stored in the tape drives 18B and that the first system ID and the second system ID match. In this case, the control unit 54 performs first control to handle the magnetic tapes T of the magnetic tape cartridges 16 having the same pool ID, which are stored in respective tape drives 18B, to be readable and writable. In a case where performing the first control, the control unit 54 writes or reads data with respect to the magnetic tape T in a case where an instruction to write or read data with respect to the magnetic tape T of the magnetic tape cartridge 16 is input from a user terminal to the information processing device 12B.

On the other hand, in a case where the determination unit 52 determines that the number of the magnetic tape cartridges 16 which is less than the predetermined number of multiplexes are stored in the tape drive 18B, the control unit 54 performs second control to handle the magnetic tape T of the magnetic tape cartridge 16 having the same pool ID, which is stored in each tape drive 18B, to be read-only. Further, in a case where the determination unit 52 determines that the first system ID and the second system ID do not match, the control unit 54 performs the second control. In a case where performing the second control, the control unit 54 does not write data to the magnetic tape T in a case where an instruction to write data with respect to the magnetic tape T of the magnetic tape cartridge 16 is input from the user terminal to the information processing device 12B. Further, in this case, the control unit 54 transmits an error message indicating that data cannot be written because the magnetic tape T is read-only, to the user terminal.

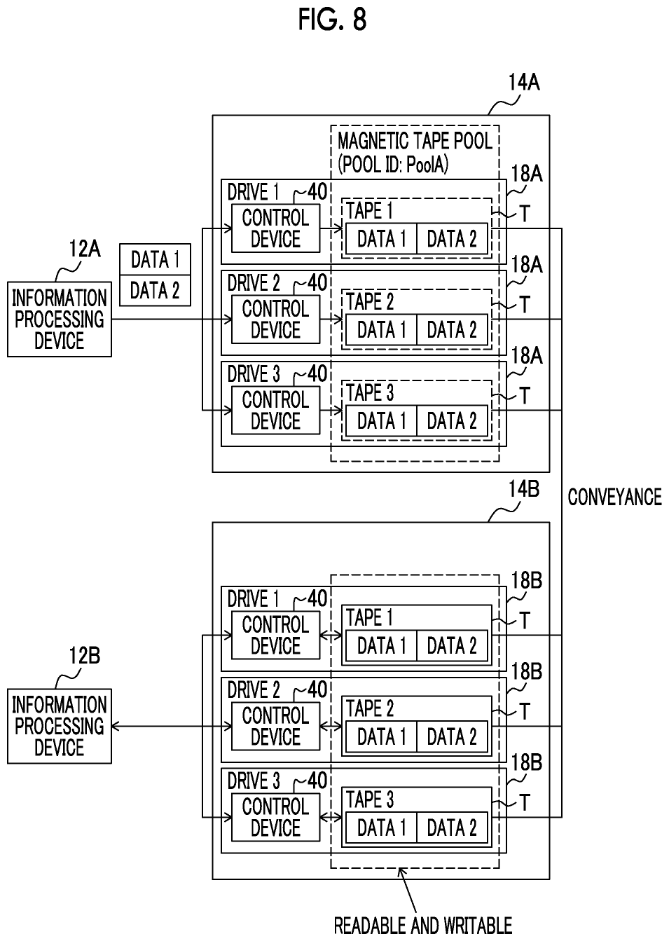

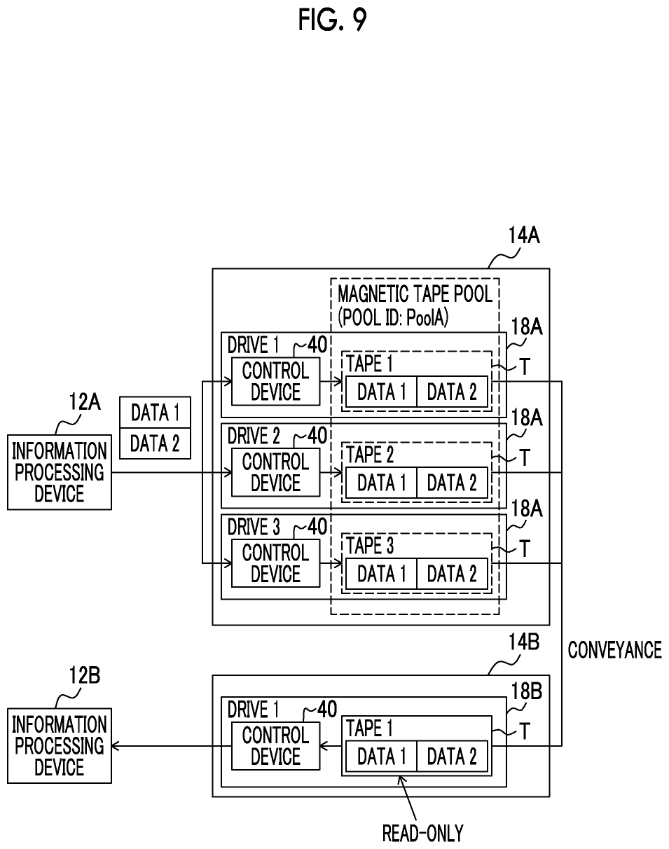

Therefore, as shown in FIG. 8, for example, in a case where three magnetic tape cartridges 16 on which data is multiplexed and recorded are conveyed and the system IDs of the conveyance source system and the conveyance destination system match, the three magnetic tape cartridges 16 are readable and writable. On the other hand, as shown in FIG. 9, for example, in a case where one magnetic tape cartridge 16, out of the three magnetic tape cartridges 16 on which data is multiplexed and recorded, is conveyed, the one magnetic tape cartridge 16 is read-only. In the example of FIG. 9, the same applies to a case where two magnetic tape cartridges 16 are conveyed.

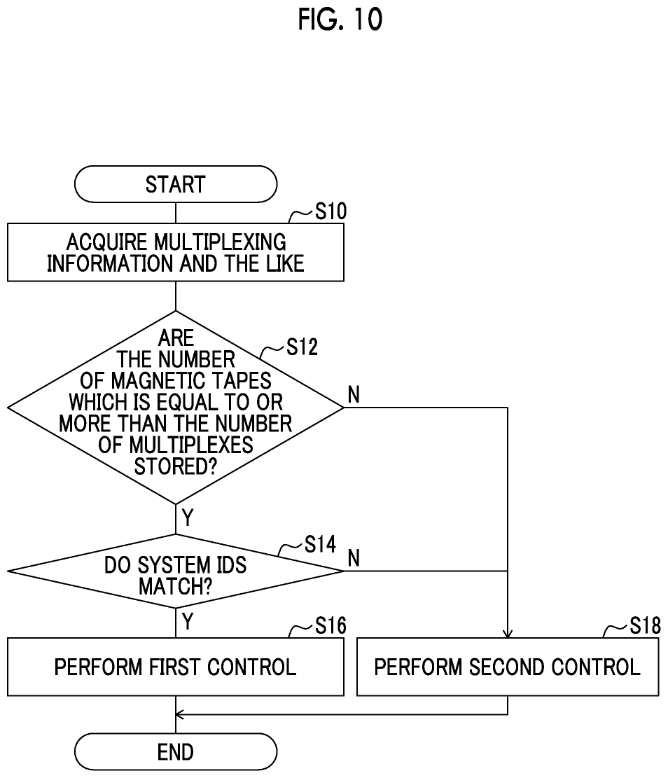

Next, an action of the information processing device 12B according to the present embodiment will be described with reference to FIG. 10. The CPU 20 executes the information processing program 30, whereby magnetic tape control processing shown in FIG. 10 is executed. The magnetic tape control processing shown in FIG. 10 is executed, for example, in a case where an execution instruction is input by the user via the input unit 24. In this case, for example, the magnetic tape cartridge 16 to be processed is designated by the user, and the designated magnetic tape cartridge 16 is stored in the tape drive 18B.

In step S10 of FIG. 10, the acquisition unit 50 acquires the system identification information 36 and the multiplexing information 38 from the magnetic tape cartridge 16 stored in each tape drive 18B, as described above.

In step S12, as described above, the determination unit 52 determines whether or not the number of the magnetic tape cartridges 16 which is equal to or more than a predetermined number of multiplexes, out of the plurality of magnetic tape cartridges 16 on which data is multiplexed and recorded, are stored in the tape drives 18B. In this determination, the process proceeds to step S18 in a case where a negative determination is made, and the process proceeds to step S14 in a case where an affirmative determination is made.

In step S14, the determination unit 52 determines whether or not the first system ID and the second system ID match, as described above. In this determination, the process proceeds to step S18 in a case where a negative determination is made, and the process proceeds to step S16 in a case where an affirmative determination is made.

In step S16, the control unit 54 performs the first control as described above. In step S18, the control unit 54 performs the second control as described above. In a case where the processing of step S16 ends, the magnetic tape control processing ends. In a case where the processing of step S18 ends, the magnetic tape control processing ends.

As described above, according to the present embodiment, it is possible to maintain the consistency of the multiplicity of data multiplexed and recorded on the magnetic tape.

In the above-described embodiment, the case where the predetermined number of multiplexes is a value equal to the number of magnetic tapes T on which data is multiplexed and recorded has been described, but the present disclosure is not limited thereto. The predetermined number of multiplexes may be a value that satisfies a majority of the number of magnetic tapes T on which the data is multiplexed and recorded.

Further, in the above-described embodiment, the case where the tape drive 18B is applied as the storage unit according to the disclosed technique has been described, but the present disclosure is not limited thereto. A slot in which the magnetic tape cartridge 16 of the tape library 14B is stored may be applied as the storage unit according to the disclosed technique. In this case, an aspect is exemplified in which the system identification information 36 and the multiplexing information 38 recorded on the RFID tag 17 are read by the reading and writing device 42 provided in a robot mechanism for taking out the magnetic tape cartridge 16 from the slot.

Further, in the above-described embodiment, the determination unit 52 may not necessarily determine whether or not the first system ID and the second system ID match. In this case, the processing of step S14 in FIG. 10 is unnecessary. Further, in this case, the system identification information 36 may not be recorded on the RFID tag 17.

Further, in the above-described embodiment, for example, the following various processors can be used as the hardware structure of a processing unit that executes various kinds of processing, such as the acquisition unit 50, the determination unit 52, and the control unit 54. The above-described various processors include, for example, a programmable logic device (PLD) which is a processor having a changeable circuit configuration after manufacture, such as a field programmable gate array (FPGA), and a dedicated electrical circuit which is a processor having a dedicated circuit configuration designed to perform specific processing, such as an application specific integrated circuit (ASIC), in addition to the CPU which is a general-purpose processor that executes software (programs) to function as various processing units, as described above.

One processing unit may be composed of one of these various processors or a combination of two or more processors of the same type or different types (for example, a combination of a plurality of FPGAs or a combination of a CPU and an FPGA). Alternatively, a plurality of processing units may be composed of one processor.

A first example in which a plurality of processing units are composed of one processor is an aspect in which one or more CPUs and software are combined to constitute one processor and the processor functions as the plurality of processing units, as typified by a computer, such as a client and a server. A second example is an aspect in which a processor that realizes all the functions of a system including the plurality of processing units with one integrated circuit (IC) chip is used, as typified by a system on chip (SoC). As described above, various processing units are formed of one or more of the above-described various processors as the hardware structure.

Further, as the hardware structure of these various processors, more specifically, an electric circuit (circuitry) in which circuit elements, such as semiconductor elements, are combined can be used.

Further, in the above-described embodiment, the aspect in which the information processing program 30 is stored (installed) in the storage unit 22 in advance has been described, but the present disclosure is not limited thereto. The information processing program 30 may be provided in a form of being recorded on a recording medium, such as a compact disc read only memory (CD-ROM), a digital versatile disc read only memory (DVD-ROM), and a Universal Serial Bus (USB) memory. Alternatively, the information processing program 30 may be downloaded from an external device via a network.

The disclosure of JP2020-034306 filed on Feb. 28, 2020 is incorporated herein by reference in its entirety. In addition, all documents, patent applications, and technical standards described in the present specification are incorporated herein by reference to the same extent as in a case of being specifically and individually noted that individual documents, patent applications, and technical standards are incorporated by reference.

What is claimed is:

1. An information processing device comprising:
at least one processor,
wherein the processor
performs, in a case where, out of a plurality of magnetic tapes on which data is multiplexed and recorded, the number of the magnetic tapes which is equal to or more than a predetermined number of multiplexes are stored in a storage unit, first control to handle each magnetic tape stored in the storage unit, to be readable and writable, and
performs, in a case where the number of the magnetic tapes which is less than the number of multiplexes are stored in the storage unit, second control to handle the magnetic tape stored in the storage unit, to be read-only.

2. The information processing device according to claim 1,
wherein the processor further acquires first identification information which is identification information of a system in which the data is recorded on the plurality of magnetic tapes, and
performs the first control in a case where second identification information, which is identification information of a system to which the information processing device belongs, and the first identification information match.

3. The information processing device according to claim 1,
wherein the predetermined number of multiplexes is a value that satisfies a majority of the number of magnetic tapes on which the data is multiplexed and recorded.

4. The information processing device according to claim 3,
wherein the predetermined number of multiplexes is a value equal to the number of magnetic tapes on which the data is multiplexed and recorded.

5. The information processing device according to claim 1,
wherein the storage unit is a slot of a tape drive or a tape library.

6. The information processing device according to claim 2,
wherein the predetermined number of multiplexes is a value that satisfies a majority of the number of magnetic tapes on which the data is multiplexed and recorded.

7. The information processing device according to claim 6,
wherein the predetermined number of multiplexes is a value equal to the number of magnetic tapes on which the data is multiplexed and recorded.

8. The information processing device according to claim 2,
wherein the storage unit is a slot of a tape drive or a tape library.

9. The information processing device according to claim 3,
wherein the storage unit is a slot of a tape drive or a tape library.

10. The information processing device according to claim 4,
wherein the storage unit is a slot of a tape drive or a tape library.

11. The information processing device according to claim 6,
wherein the storage unit is a slot of a tape drive or a tape library.

12. The information processing device according to claim 7,
wherein the storage unit is a slot of a tape drive or a tape library.

13. An information processing method executed by a processor provided in an information processing device, the method comprising:
performing, in a case where, out of a plurality of magnetic tapes on which data is multiplexed and recorded, the number of the magnetic tapes which is equal to or more than a predetermined number of multiplexes are stored in a storage unit, first control to handle each magnetic tape stored in the storage unit, to be readable and writable; and
performing, in a case where the number of the magnetic tapes which is less than the number of multiplexes are stored in the storage unit, second control to handle the magnetic tape stored in the storage unit, to be read-only.

14. A non-transitory computer-readable storage medium storing an information processing program for causing a processor provided in an information processing device to execute a process comprising:
performing, in a case where, out of a plurality of magnetic tapes on which data is multiplexed and recorded, the number of the magnetic tapes which is equal to or more than a predetermined number of multiplexes are stored in a storage unit, first control to handle each magnetic tape stored in the storage unit, to be readable and writable; and
performing, in a case where the number of the magnetic tapes which is less than the number of multiplexes are stored in the storage unit, second control to handle the magnetic tape stored in the storage unit, to be read-only.
